(19) United States
(12) Patent Application Publication
(10) Pub. No.: US 2011/0282980 A1
(43) Pub. Date: Nov. 17, 2011

(54) DYNAMIC PROTECTION OF A RESOURCE DURING SUDDEN SURGES IN TRAFFIC

(76) Inventors: UDAYA KUMAR, Dublin (IE); Louay Gargoum, Killiney (IE)

(21) Appl. No.: 12/777,619

(22) Filed: May 11, 2010

(51) Int. Cl. G06F 15/173

(52) U.S. Cl. 709/223

(57) ABSTRACT

Various embodiments of systems and methods for dynamically protecting a server during sudden surges in traffic are described herein. A gatekeeper is triggered by an incoming system request. Based upon queue size associated with the server and expiration of the elements of the queue, the gatekeeper determines whether to forward the incoming system request to the server. The queue size comprises a maximum allowable load within a time window. The expired elements in the queue are removed by comparing the difference of current time and time-stamped time, with time window. If the queue is not full or even if the queue is full but one of the elements in the queue is expired, the incoming system request may be forwarded to the server. If the queue is full and there are no expired elements in the queue, the incoming system request may be dropped.

### FIELD

Embodiments generally relate to computer systems, and more particularly to methods and systems for dynamic protection of a server during sudden surges in traffic.

### BACKGROUND

Critical resources like servers may experience sudden increase and/or decrease in load. At times, significant increase in demand for the server due to sudden surges in traffic may render services unavailable or unresponsive, degrade performance, and may eventually result in a crash. This leaves the system vulnerable to service attacks and unable to deal with periods of intense demand.

There are existing methods for protecting the server during sudden surges in traffic. One of these methods involves limiting the volume of user logins into the application. The other method involves limiting user licenses. Yet another method involves customizing applications to support surge protection.

However, the methods mentioned above have one or more of the following limitations. First, limiting user logins requires an authentication component to support the feature. Further, not all vendors may implement the feature, and in such a case, the vendor implementation may be extended. Second, limiting peak load with user licenses may prove to be very expensive to the user, since user licenses have to be purchased. Finally, customizing applications to support surge protection requires deploying the changes and introducing such changes may require downtime of the application.

In general, maintaining the load of the server mostly depends on an authentication provider, a load balancer or number of licenses or changes in the application. Changing the behavior of the gatekeeper may also require interruptions like server restarts. Therefore, protecting a server during a sudden surge in traffic, dynamically, without anticipated downtime or additional costs to ensure better user experience would be desirable.

### SUMMARY

Various embodiments of systems and methods for dynamic protection of a resource during sudden surges in traffic are described herein. A gatekeeper is triggered by an incoming system request. Based upon the queue size associated with the server and expiration of the elements of the queue, the gatekeeper determines whether to forward the incoming system request to the server. The queue size comprises a maximum allowable load within a time window, which can be changed dynamically, without interrupting any processing by the server or any act requiring the restart of a server. One or more elements in the queue are selected, when the queue is full, to remove one or more expired elements in the queue based on first-in-first-out (FIFO) approach. The one or more expired elements in the queue are removed by comparing the difference of current time and time-stamped time associated with the element, with the time window. If the queue is not full or even if the queue is full but one of the elements in the queue is expired, the incoming system request may be forwarded to the server. If the queue is full and one or more elements in the queue have not expired, the incoming system request may be dropped by the gatekeeper, thus protecting the server from sudden surges in traffic.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating an overall general process for dynamically protecting a server during a sudden surge in traffic, according to an embodiment.

FIG. 2 is a diagrammatic representation of a queue in a gatekeeper, according to an embodiment.

FIG. 3 is a flow diagram illustrating an exemplary process for dynamically protecting a server during a sudden surge in traffic, according to an embodiment.

FIG. 4 is a flow diagram illustrating another exemplary process for dynamically protecting a server during a sudden surge in traffic, according to an embodiment.

FIG. 5 is block diagram illustrating an exploded view of a gatekeeper, according to an embodiment.

FIG. 6 is a block diagram providing a conceptual illustration of a system for dynamically protecting a server by a gatekeeper, according to an embodiment.

FIG. 7 is a block diagram providing a conceptual illustration of a system for dynamically protecting a plurality of servers by a gatekeeper, according to an embodiment.

FIG. 8 is a block diagram illustrating a computing environment in which the techniques described for dynamically protecting a server during sudden surges in traffic can be implemented, according to an embodiment.

### DETAILED DESCRIPTION

Embodiments of techniques for methods and systems for dynamic protection of a resource during sudden surges in traffic are described herein. The resource may be a host computer on a network that stores information and provides access to the stored information. A sudden increase in the number of incoming system requests for accessing an application in a server is typically referred to as a surge in traffic. A lightweight gatekeeper, whose configuration may be changed dynamically without affecting an executing application or restarting the server, can be implemented to protect the server during sudden surges in traffic. The gatekeeper maintains a queue to monitor the number of system requests that are processed on the server and a time-stamp recorder to record the absolute time at which the incoming system request is forwarded to the server. The size of the queue comprises a maximum allowable load which can be handled by a server or a group of servers within a time window. This queue size and time window parameters can be dynamically changed without interrupting any processing by the server or any act requiring the restart of server. Each element in the queue is associated with a recorded time-stamped time.

The gatekeeper determines whether to forward the incoming system request to the server based on the rate at which the incoming system requests are received. The implementation of the gatekeeper need not be dependent on existing resources or infrastructure. By utilizing this approach, the server may be protected during sudden surges in traffic without additional costs, and since the gatekeeper assists in early detection of surges in traffic, anticipated downtime may also be avoided. Also, the implementation ensures a better user experience.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

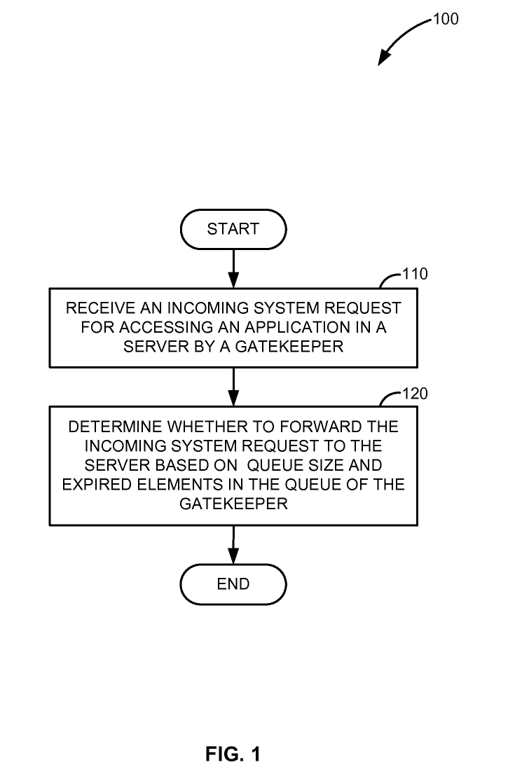

FIG. 1 is a flow diagram illustrating an overall general process 100 for dynamically protecting a server during a sudden surge in traffic, according to an embodiment. At step 110, an incoming system request is received by a gatekeeper for accessing an application in the server. At step 120, the gatekeeper determines whether to forward the incoming system request to the server based on queue size associated with the server and expiration of one or more elements of the queue. In one embodiment, the queue size comprises a maximum allowable load within a time window. The maximum allowable load need not be the maximum capacity of the server; however, maximum allowable load is the maximum load that the server is designated to handle within the time window. Each element in the queue includes a time-stamp at which the incoming system request is forwarded to the server. If the queue is not full or even if the queue is full but one of the elements in the queue is expired, the incoming system request may be forwarded to the server. If the queue is full and one or more elements in the queue have not expired, the incoming system request may be dropped by the gatekeeper.

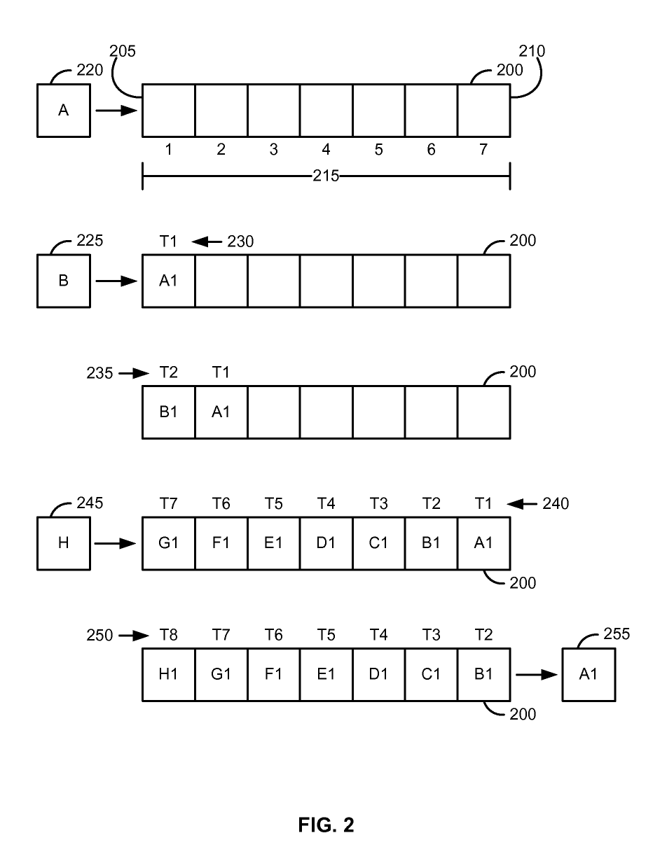

FIG. 2 is a diagrammatic representation of a queue 200 in a gatekeeper, according to an embodiment. The queue 200 comprises an ordered list of elements. In one embodiment, the queue 200 exercises a first-in-first-out (FIFO) approach. In FIFO queue 200, the elements are added to the queue 200 through the rear terminal position 205 and removed from the front terminal position 210. The queue size comprises a maximum allowable load within a time window 215. For example, queue size or the maximum allowable load is 7 incoming system requests within the time window 215 of 10 minutes in FIG. 2. In operation, when an incoming system request ‘A’ 220 is received by the gatekeeper, a check is performed to determine whether the queue 200 is full or not. Since the queue 200 is not full, the first element ‘A1’ is stacked onto the queue 200 in the FIFO approach and the incoming system request ‘A’ 220 is forwarded to the server. The first element ‘A1’ includes a time-stamp T1 230 at which the system request ‘A’ 220 is forwarded to the server. Further, when an incoming system request ‘B’ 225 is received by the gatekeeper, the check determines whether the queue 200 is full or not. Since the queue 200 is not full, the element ‘B1’ is stacked onto the queue 200. The element ‘B1’ includes a time-stamp T2 235 at which the system request ‘B’ 225 is forwarded to the server. Similarly, the incoming system requests C to G are processed as in 240.

Further, when an incoming system request ‘H’ 245 is received by the gatekeeper, the check determines whether the queue 200 is full or not. Now, the queue 200 is full. In other words, the queue 200 reaches the maximum allowable load within the time window 215. At this instance, a check is performed to determine whether the first element ‘A1’ is expired. Since ‘A1’ is the first element stacked to the queue, the element ‘A1’ may be the first one expected to expire. The determination of the expiration of ‘A1’ is performed by comparing the difference of current time and time-stamped time T1, with the time window 215 of 10 minutes. The incoming system request ‘H’ 245 is dropped if the difference is less than 10 minutes. If the difference is greater than or equal to 10 minutes, the element ‘A1’ is removed from the queue 200 as shown at 255. Further, the incoming system request ‘H’ 245 is forwarded to the server by stacking element ‘H1’ in the queue 200. The element ‘H1’ includes a time-stamp T8 250 at which the system request ‘H’ 245 is forwarded to the server. Similarly, a plurality of incoming system requests are processed by the gatekeeper by verifying whether the queue is full and clearing the queue of expired elements. Several techniques for verifying the expiration and clearing the queue of the expired elements are described in greater detail below.

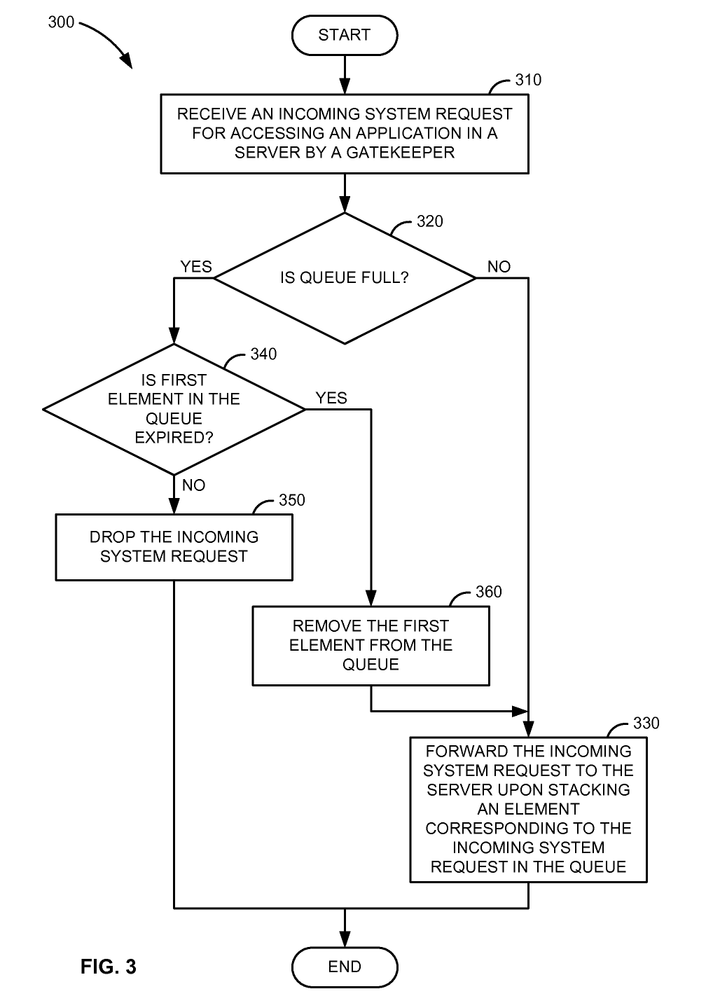

FIG. 3 is a flow diagram illustrating an exemplary process 300 for dynamically protecting a server during a sudden surge in traffic, according to an embodiment. At step 310, an incoming system request is received by a gatekeeper for accessing an application in the server. At step 320, a check is performed to determine whether a queue of the gatekeeper is full. The queue size comprises the maximum allowable load within a time window. If the queue is not full, an element corresponding to the incoming system request is stacked in the queue and the incoming system request is forwarded to the server as in step 330. Elements of the queue have a time-stamp at which the incoming system request is forwarded to the server.

In one embodiment, a check is performed to determine whether a first element of the queue is expired based on first-in-first-out (FIFO) approach, if the queue is full as in step 340. The first element that entered the queue is most likely to expire as the queue is processed in FIFO approach.

In one example embodiment, whether the first element in the queue is expired or not is determined by comparing the difference of current time and time-stamped time associated with first element, with the time window. At step 350, the incoming system request is dropped if the difference is less than the time window. At step 360, the first element in the queue is removed from the queue if the difference is greater than or equal to the time window. Further, the incoming system request is forwarded to the server upon stacking the element corresponding to the incoming system request in the queue as in step 330. The above mentioned steps of determining, removing, stacking and forwarding are repeated for the plurality of incoming system requests.

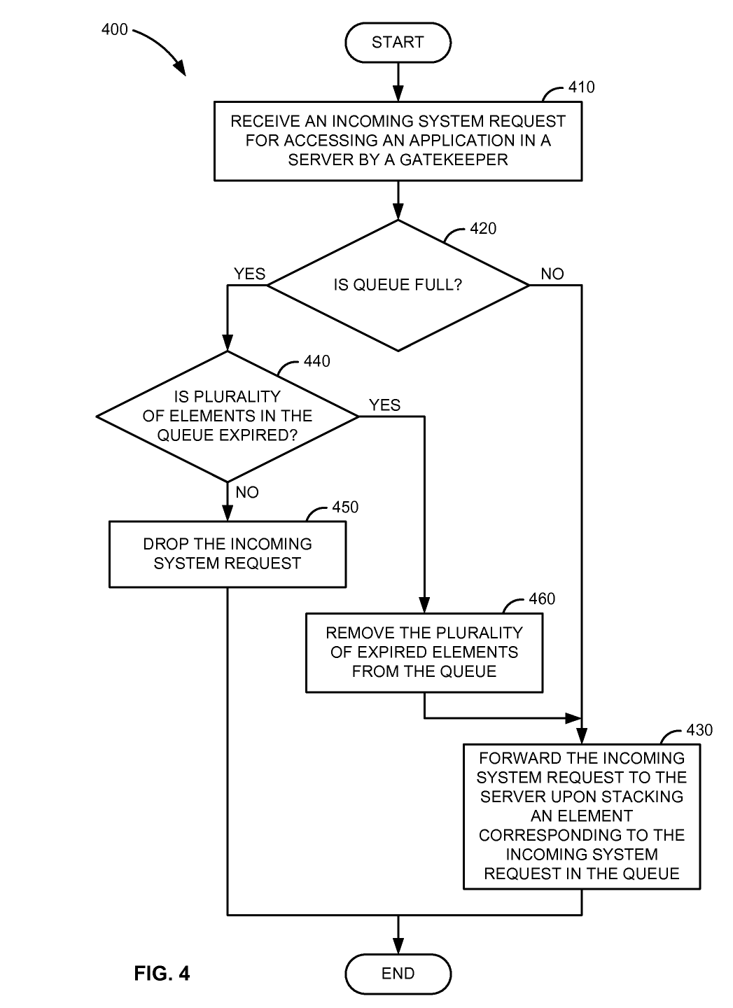

FIG. 4 is a flow diagram illustrating another exemplary process 400 for protecting a server during a sudden surge in traffic, according to an embodiment. At step 410, an incoming system request is received by a gatekeeper for accessing an application in a server. At step 420, a check is performed to determine whether a queue of the gatekeeper is full. The queue size comprises a maximum allowable load within a time window. If the queue is not full, the incoming system request is forwarded to the server upon stacking an element corresponding to the incoming system request on the queue as in step 430. Elements of the queue have a time-stamp at which the incoming system request is forwarded to the server.

In one embodiment, a check is performed to determine whether a plurality of elements of the queue (e.g., not just the first one) are expired based on first-in-first-out (FIFO) approach, if the queue is full as in step 440. In one example embodiment, whether the plurality of elements in the queue is expired is determined by comparing the difference of current time and time-stamped time associated with the element, with the time window. The expired elements in the queue are determined recursively until the element in the queue is not expired. This is done to optimize the process of determination of the expired elements in the queue for every incoming system request after the queue is full. At step 450, the incoming system request is dropped if none of the elements in the queue have expired i.e., the difference is less than the time window. At step 460, a plurality of expired elements in the queue is removed from the queue if the difference is greater than or equal to the time window. Further, the incoming system request is forwarded to the server upon stacking the element corresponding to the incoming system request as in step 430. The above mentioned steps of determining, removing, stacking and forwarding are repeated for a plurality of incoming system requests.

In yet another embodiment, the process of determining whether one or more elements in a queue are expired and removing one or more expired elements from the queue are performed in parallel to the process of determining whether the queue is full to monitor the elements of the queue constantly. The process of removing one or more expired elements in the queue may be independent to the condition of whether the queue is full. The expired one or more elements in the queue can be removed using any of the processes as described above with respect to FIG. 3 and FIG. 4.

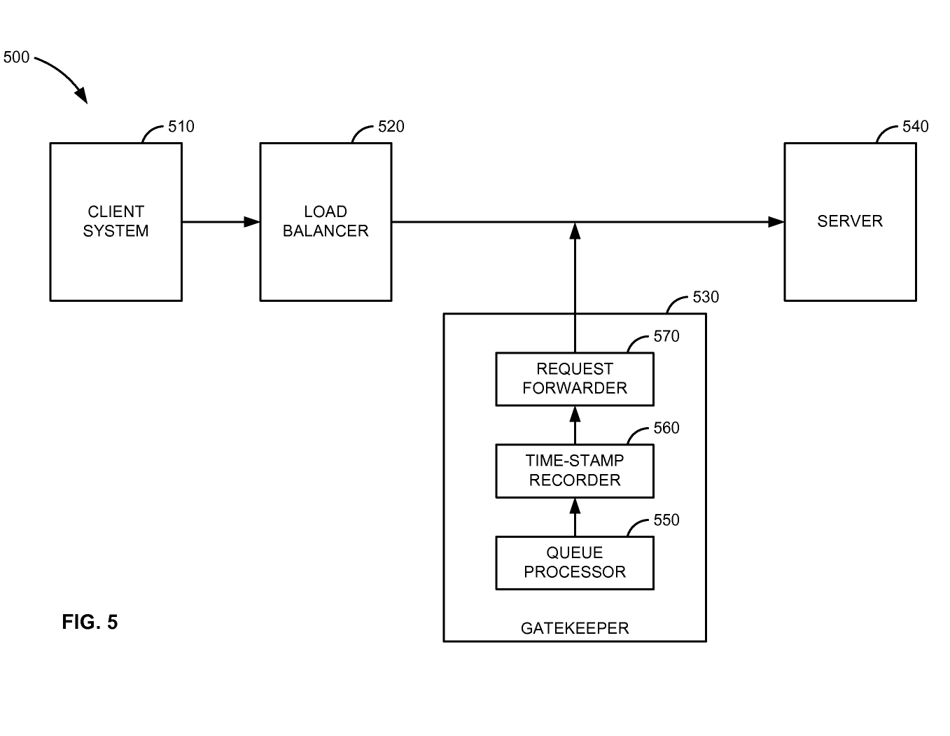

FIG. 5 is an exploded view of a gatekeeper, according to an embodiment. More particularly, a system 500 includes a client system 510 for sending a plurality of incoming system requests for accessing an application in the server 540 via a load balancer 520 and a gatekeeper 530. In one embodiment, the gatekeeper 530 includes a queue processor 550, a time-stamp recorder 560, and a request forwarder 570.

In one embodiment, the gatekeeper 530 is configured to receive the plurality of incoming system requests from the client system 510 for accessing the application in the server 540 through the load balancer 520. In one example embodiment, the gatekeeper 530 is triggered by the incoming system request and hence the gatekeeper is inactive when there are no incoming system requests. Thus, the power required by the gatekeeper 530 is minimal.

In one embodiment, the queue processor 550 accesses a queue, wherein the queue size comprises a maximum allowable load within a time window. The queue processor 550 is configured to determine whether the queue is full and whether one or more elements in the queue are expired. Further, the queue processor 550 removes one or more expired elements from the queue. The steps executed in the queue processor 550 are lightweight and quick, making the gatekeeper 530 fast and responsive to sudden surges in traffic. Thus, the processing time of the gatekeeper 530 is minimal.

In one embodiment, the time-stamp recorder 560 records the time-stamp of the incoming system request, wherein the time-stamp is an absolute time at which the incoming system request is forwarded to the server 540.

In one embodiment, the request forwarder 570 directs the incoming system request to the server 540 upon stacking an element associated with the incoming system request on to the queue. Elements of the queue have a time-stamp at which the incoming system request is forwarded to the server. For instance, file application properties may be used to define the pages to direct the incoming system requests by the gatekeeper 530. The successful incoming system requests are forwarded through a preconfigured URL to the server 540 such as SERVER_240=APPLICATION_URL_1, and the like. Further, the gatekeeper 230 drops the incoming system request, if the queue is full and one or more elements in the queue are not expired. The dropped incoming system requests are directed through a URL such as SERVER_BUSY_PAGE=SOME_PAGE_URL. The SERVER_BUSY_PAGE=SOME_PAGE_URL includes an option to retry for accessing the application in the server some time later.

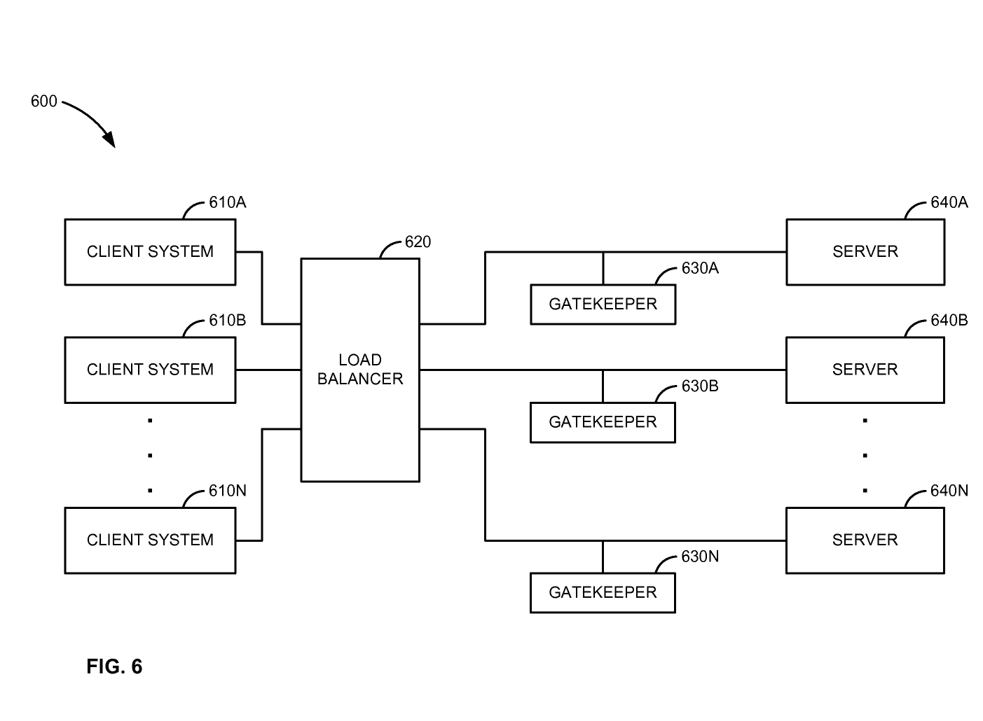

FIG. 6 is a block diagram providing a conceptual illustration of a system 600 for dynamically protecting a server during sudden surges in traffic by a gatekeeper, according to an embodiment. Particularly, the system 600 includes one or more client systems 610A to 610N for sending a plurality of incoming system requests to one or more servers 640A to 640N via a load balancer 620 and a plurality of gatekeepers 630A to 630N. As illustrated in FIG. 6, a gatekeeper is coupled to one of the plurality of servers 640A to 640N (e.g., gatekeeper 630A is coupled to server 640A, gatekeeper 630B is coupled to server 640B, and so on).

In one embodiment, at least some of the gatekeepers of the plurality of gatekeepers 630A to 630N are configured to the parameters of the coupled server of one or more servers 640A to 640N. The parameters may include maximum allowable load within a time window, an address of the server, and the like. The parameters may be dynamically changed without affecting an executing application or restarting the server. For example, a gatekeeper 630A is configured to the parameters of a server 640A, a gatekeeper 630B is configured to the parameters of a server 640B, and so on.

In operation, the plurality of incoming system requests for accessing the application in one or more servers 640A to 640N are received from one or more client systems 610A to 610N through the load balancer 620. The plurality of incoming system requests from the load balancer 620 may include the address of the server for which an incoming system request of the plurality of incoming system requests is directed. For instance, the gatekeeper 630A is triggered by the incoming system request with the address of server 640A. Further, the gatekeeper 630A determines whether to forward the incoming system request to the server 640A. Similar process is followed by the plurality of gatekeepers 630B to 630N.

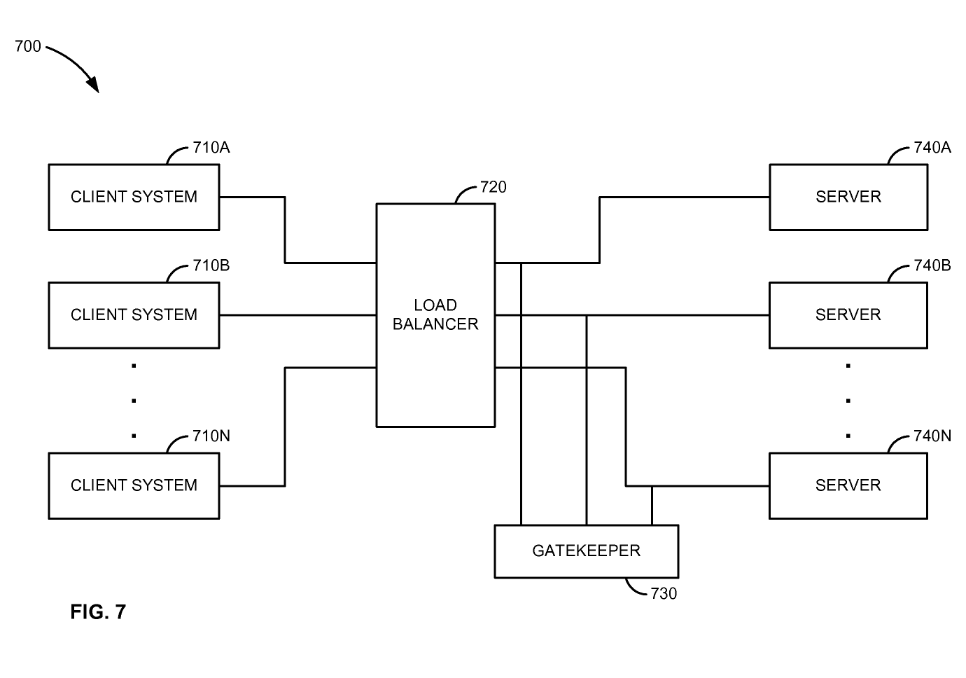

FIG. 7 is a block diagram providing a conceptual illustration of a system 700 for dynamically protecting a plurality of servers during sudden surges in traffic by a gatekeeper, according to an embodiment. Particularly, the system 700 includes one or more client systems 710A to 710N for sending a plurality of incoming system requests to one or more servers 740A to 740N via a load balancer 720 and a gatekeeper 730. As illustrated in FIG. 7, the gatekeeper 730 is coupled to the plurality of servers 740A to 740N. The gatekeeper 730 is configured to the parameters of one or more servers 740A to 740N, which can be dynamically changed without affecting an executing application or restarting the server. The parameters may include maximum allowable load within a time window, an address of the server, and the like.

In operation, the plurality of incoming system requests for accessing the application in one or more servers 740A to 740N are received from one or more client systems 710A to 710N through the load balancer 720. The plurality of incoming system requests from the load balancer 720 may include the address of the server for which an incoming system request of plurality of incoming system requests is directed. For example, the gatekeeper 730 is triggered by the incoming system request with the address of server 740A. Further, the gatekeeper 730 determines whether to forward the incoming system request to the server 740A. Similar process is followed for the plurality of servers 740B to 740N.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

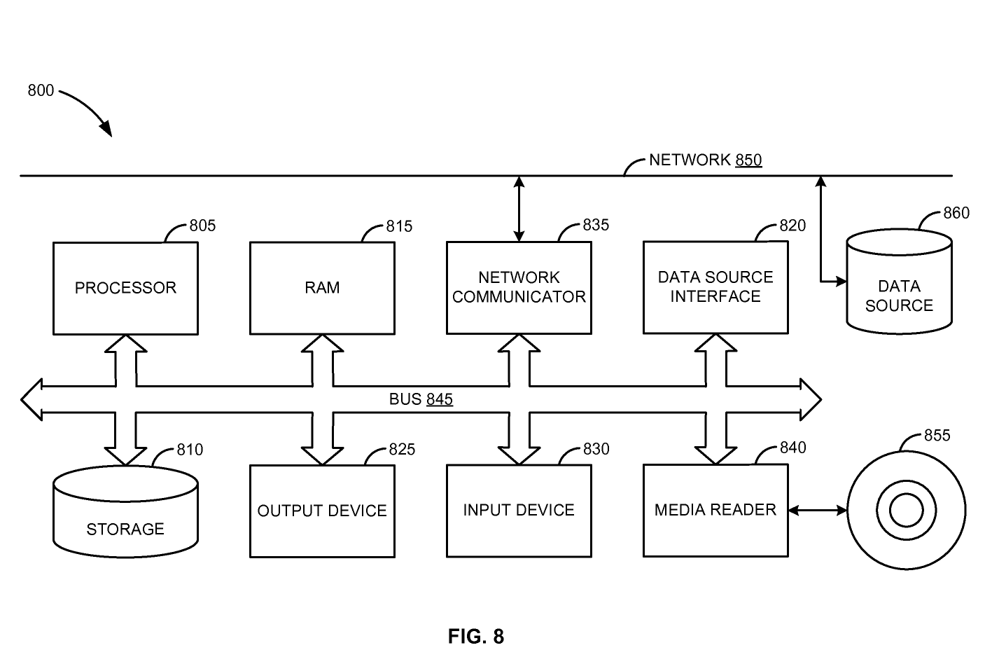

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in detail to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a tangible computer readable storage medium to store instructions, which when executed by a computer, cause the computer to:
receive an incoming system request for accessing an application in a server by a gatekeeper;
determine whether a queue in the gatekeeper is full;
if the queue is full, determine whether one or more elements in the queue are expired;
if the one or more elements in the queue are expired, remove the expired one or more elements from the queue; and
forward the incoming system request to the server upon stacking an element corresponding to the incoming system request in the queue.

2. The article of claim 1, further comprising:
if the queue is not full, forward the incoming system request to the server upon stacking the element corresponding to the incoming system request in the queue.

3. The article of claim 1, further comprising:
if none of the one or more elements in the queue are expired, drop the incoming system request.

4. A computerized method for dynamically protecting a server during sudden surges in traffic, the method comprising:
receiving an incoming system request for accessing an application in the server by a gatekeeper;
determining whether a queue in the gatekeeper is full;
if the queue is full, determining whether one or more elements in the queue are expired;
if the one or more elements in the queue are expired, removing the expired one or more elements in the queue; and
forwarding the incoming system request to the server upon stacking an element corresponding to the incoming system request in the queue.

5. The method of claim 4, further comprising:
if the queue is not full, forwarding the incoming system request to the server upon stacking the element corresponding to the incoming system request in the queue.

6. The method of claim 4, further comprising:
if one or more elements in the queue are not expired, dropping the incoming system request.

7. The method of claim 4, wherein the element in the queue comprises a time-stamp indicating an absolute time at which the incoming system request is forwarded to the server.

8. The method of claim 4, wherein a queue size comprises a maximum allowable load that the server is designated to handle within a time window.

9. The method of claim 8, wherein determining whether one or more elements in the queue are expired comprises:
selecting a first element in the queue based on first-in-first-out (FIFO) approach; and
determining whether the first element in the queue is expired by comparing a difference of current time and time-stamped time associated with first element, with the time window.

10. The method of claim 8, wherein determining whether one or more elements in the queue are expired comprises:
selecting a plurality of elements in the queue based on first-in-first-out (FIFO) approach; and
determining whether the plurality of elements in the queue are expired by comparing a difference of current time and time-stamped time associated with the plurality of elements, with the time window.

11. The method of claim 4, wherein determining whether the one or more elements in the queue are expired and removing the one or more expired elements from the queue are performed in parallel with determining whether the queue is full.

12. A computer system for dynamically protecting a server during sudden surges in traffic, comprising:
a memory to store program code;
a processor to execute the program code; and
a gatekeeper residing in the memory; wherein the gatekeeper is configured to receive an incoming system request for accessing an application in the server, and wherein the gatekeeper comprises:
a queue processor configured to:
determine whether a queue is full;
determine whether one or more elements in the queue are expired, if the queue is full; and
remove the one or more expired elements in the queue, if the one or more elements in the queue are expired;
a time-stamp recorder to record a time-stamp of the incoming system request; and
a request forwarder to forward the incoming system request to the server upon stacking an element corresponding to the incoming system request on the queue.

13. The system of claim 12, wherein the request forwarder forwards the incoming system request to the server upon stacking the element corresponding to the incoming system request in the queue, if the queue is not full.

14. The system of claim 12, wherein the gatekeeper drops the incoming system request, if the one or more elements in the queue are not expired.

15. The system of claim 12, wherein the element in the queue comprises the time-stamp indicating an absolute time at which the incoming system request is forwarded to the server.

16. The system of claim 12, wherein a queue size comprises a maximum allowable load that the server is designated to handle within a time window.

17. The system of claim 16, wherein the queue processor selects a first element in the queue based on first-in-first-out (FIFO) approach, and determines whether the first element in the queue is expired by comparing a difference of current time and time-stamped time associated with the first element, with the time window.

18. The system of claim 16, wherein the queue processor selects a plurality of elements in the queue based on first-in-first-out (FIFO) approach, and determines whether the plurality of elements in the queue are expired by comparing a difference of current time and time-stamped time associated with the plurality of elements, with the time window.

19. The system of claim 12, wherein the queue processor determines whether one or more elements in the queue are expired in parallel with determining whether the queue is full.
